(19) United States
(12) Patent Application Publication
(10) Pub. No.: US 2018/0241047 A1
(43) Pub. Date: Aug. 23, 2018

(54) P/METAL-N-C HYBRID CATALYST

(71) Applicants: CENTRE NATIONAL DE LA RECHERCHE SCIENTIFIQUE, Paris (FR); UNIVERSITÉ DE MONTPELLIER, Montpellier (FR)

(72) Inventors: Anna SCHUPPERT, Hagen (DE); Frédéric JAOUEN, Montpellier (FR); Deborah JONES, Saint Martin de Londres (FR)

(73) Assignees: CENTRE NATIONAL DE LA RECHERCHE SCIENTIFIQUE, Paris (FR); UNIVERSITÉ DE MONTPELLIER, Montpellier (FR)

(21) Appl. No.: 15/759,505

(22) PCT Filed: Sep. 12, 2016
(86) PCT No.: PCT/FR2016/052289

§ 371 Date: Mar. 12, 2018

(30) Foreign Application Priority Data
Sep. 11, 2015 (FR) 15/58452

(51) Int. Cl. H01M 4/92; H01M 8/10; H01M 4/88; H01M 4/86

(52) U.S. Cl. CPC H01M 4/926; H01M 8/10; H01M 2008/1095; H01M 4/8882; H01M 4/8652; H01M 4/921

(57) ABSTRACT

A P/Metal-N—C hybrid catalyst that includes at least one nitrogen-doped carbonaceous matrix onto which at least one non-precious transition metal is covalently bonded and that includes at least one partially oxidised precious transition metal P of which the weight percentage is less than or equal to 4.0%, and preferably less than or equal to 2.0%, relative to the mass of the P/Metal-N—C hybrid catalyst. Further, an electrochemical device that includes such a device, for example a fuel cell with a polymer electrolyte membrane.

The present invention concerns a hybrid catalyst intended for the production of electrical energy from chemical energy in various energy electrochemical conversion devices such as a polymer electrolyte membrane fuel cell (hereinafter abbreviated as «PEMFC»).

The electrochemical conversion devices having the highest energy density are those in which dioxygen is used as an oxidizer, because dioxygen is available in the air and has not therefore to be stored in the vehicle or in the appliance. The dioxygen is electrochemically reduced into water during the production of electrical energy in these systems. At low temperature (namely up to 200° C.), this complex electrochemical reaction requires adequate catalysts in order to reach acceptable power densities.

In the context of the present invention, by transition metal, is meant an element which has an incomplete subshell d or which may give a cation having an incomplete subshell d. Hence, this definition which is also provided by the international union of pure and applied chemistry (IUPAC) encompasses all lanthanides and actinides.

In the context of the present invention, by «Metal-N—C type catalyst», is meant a catalyst comprising a nitrogen-doped carbonaceous matrix on which is bonded in a covalent manner at least one non-precious transition metal. The non-precious transition metals may be selected from titanium, vanadium, chromium, manganese, nickel, copper, iron and cobalt. Preferably, it consists of iron and cobalt. Thus, a Fe—N—C type catalyst and a Co—N—C type catalyst are catalysts which, respectively, comprise iron and cobalt as a transition metal. The non-precious transition metals constitute active sites of these Metal-N—C type catalysts.

In the context of the present invention, by «P/Metal-N—C type hybrid catalyst», is meant a Metal-N—C type catalyst which further comprises at least one precious transition metal P. Said precious transition metals P may be selected from ruthenium, rhodium, palladium, silver, gold, rhenium, osmium, iridium, platinum and cerium. Preferably, it consists of platinum. Such hybrid catalysts comprise at least one of these precious transition metals or an alloy of these precious transition metals.

To date, the catalytic principle of the P/Metal-N—C type hybrid catalysts considered for various devices such as PEMFCs lies mainly in the reactivity of the precious transition metal atoms such as platinum for the oxygen reduction. In this respect, the publication of Gang Wu et al. entitled «Nitrogen-doped magnetic onion-like carbon as support for Pt particles in a hybrid cathod catalyst for fuel cells», Journal of materials chemistry, Royal society of chemistry, GB, vol. 10, 2010, pages 3059-3068, describes an example of such P/Metal-N—C type hybrid catalysts. These P/Metal-N—C hybrid catalysts are characterized by a higher catalytic activity than that of the Metal-N—C reference materials synthesized in an identical manner but without any subsequent deposition of precious metal P. This is why the PEMFC cathodes comprising P/Metal-N—C type hybrid catalysts or comprising non-hybrid catalysts based on precious transition metal particles (for example platinum) supported on a non-catalytic material require a relatively high weight of precious transition metal generally comprised between 0.2 and 0.4 mg per square centimeter of electrode. For example, it may consist of a weight of 0.4 g of platinum per kW of electric power produced by a PEMFC cell, namely 40 g of platinum for a motor vehicle having a power of 100 kW.

Another drawback of the catalysts described hereinabove and whose catalytic activity originates mainly from the precious transition metal atoms is their poisoning by a considerable number of chemical substances that may originate either from the fuel, or from the air used at the cathode. For example, the platinum surface is rapidly poisoned in the presence of carbon monoxide or ammonia (present in the dihydrogen reformed from natural gas) or in the presence of halide anions (F⁻, Cl⁻, Br⁻, I⁻) which may be found in the atmosphere, the oxidizer of the cathode of fuel cells and metal-air batteries.

Furthermore, the non-hybrid catalysts based on precious transition metals (for example platinum) and the current P/Metal-N—C type hybrid catalysts are non-selective. Indeed, not only do they catalyze the reduction of dioxygen into water, but also the reduction of hydrogen peroxide into water. This allows the elimination of the hydrogen peroxide formed in a small amount during the main reaction of reduction of dioxygen into water in the electrochemical device.

The non-hybrid catalysts based on precious transition metals (for example platinum) and the current P/Metal-N—C type hybrid catalysts have good electrochemical performances.

However, because of the catalytic principle based on the reactivity of the precious transition metal atoms, the weight of the precious transition metal in the electrodes comprising non-hybrid catalysts based on precious transition metals (for example platinum) or current P/Metal-N—C type hybrid catalysts is high; which induces considerable manufacturing costs of these catalysts because of the high cost of their raw materials. In addition, the scarcity of the precious transition metals and their low global annual production (for example, about 200 tons of platinum are produced each year) also constitute obstacles to their implementation in vehicles propelled with PEMFCs or in other applications intended for the general public such as mobile electronic devices for which the production series are considerable.

This is why, considering these drawbacks with regards to the supply of precious transition metals for the non-hybrid catalysts based on precious transition metals or the P/Metal-N—C type hybrid catalysts, efforts have been pursued to develop other catalysts which are sufficiently catalytic while being devoid of these precious transition metals. Hence, focus has been placed on the Metal-N—C type catalysts.

Thus, major advances have been made these last years in the synthesis and in the properties of the Metal-N—C type catalysts used for the electrochemical reduction of dioxygen.

However, if the activities and the performances of such catalysts are now acceptable at the beginning of the operation of the electrochemical device, the durability of such catalysts is still very limited resulting in a short life span of the electrochemical system. Indeed, a decrease of the performances is already observable after only few hours of operation of the electrochemical device, while a technological application of these electrodes might require a life span of several hundreds or thousands of hours.

Thus, the Metal-N—C type catalysts have the drawback of having a low durability, and in particular a low durability when they are used for the electrochemical reduction of oxygen, for example in a PEMFC, in particular in PEMFCs with a proton-conductive acid electrolyte.

The mechanisms of degradation of the Metal-N—C type catalysts are still little known. A recent study of the laboratory of the Applicants have demonstrated that the small amounts of hydrogen peroxide produced during the electrochemical reduction of dioxygen into water are at the origin of the major portion of the degradation of these catalysts during the stationary operation of the electrode.

Indeed, on the contrary of the P/Metal-N—C type hybrid catalysts which are non-selective, the Metal-N—C type catalysts are selective: they catalyze almost only but the dioxygen reduction and are barely capable of catalyzing the reduction of hydrogen peroxide into water.

This is why, in the electrochemical devices comprising a Metal-N—C type catalyst used to catalyze the reduction of dioxygen into water, the hydrogen peroxide formed in parallel during the reduction of dioxygen into water accumulates in the electrolyte or in the electrode and chemically reacts with the non-precious transition metal based active sites so as to form very oxidant radical species (for example through a Fenton type reaction). These radical species then attack the Metal-N—C type catalyst and/or the polymer electrolyte integrated in the electrode, thereby considerably reducing the life span of the electrochemical device.

The present invention overcomes these drawbacks regarding the Metal-N—C type catalysts by providing a new P/Metal-N—C type hybrid catalyst stable over time and which also does not have the drawbacks inherent to the precious transition metal based non-hybrid catalysts or to the P/Metal-N—C type hybrid catalysts known up to now and which have been recalled hereinabove, namely their production costs because of expensive raw materials, the large amount of precious transition metal required per electric kW and their rapid poisoning by a considerable number of chemical substances likely to be present in such electrochemical devices.

The performance of an electrode comprising a P/Metal-N—C type hybrid catalyst according to the invention remains stable over time during the operation at the cathode of a PEMFC.

The P/Metal-N—C hybrid catalyst according to the invention has a greater durability than the Metal-N—C type catalysts known up to now.

Thus, an object of the present invention is a P/Metal-N—C type hybrid catalyst which comprises at least one nitrogen-doped carbonaceous matrix on which is bonded in a covalent manner at least one non-precious transition metal, said catalysts is characterized in that it further comprises at least one precious transition metal P partially oxidized and whose weight percentage is lower than or equal to 4.0%, preferably lower than or equal to 2.0%, with respect to the weight of said P/Metal-N—C type hybrid catalyst.

In the context of the present invention, by «partially oxidized precious transition metal P», is meant a precious transition metal P which has an average oxidation state comprised between 0.5 and 4.0, preferably between 0.5 and 2.5.

In the context of the present invention, by «average oxidation state» of a precious transition metal P, is meant the value that would have been obtained by summing up the oxidation state of each precious metal P atom present in the catalyst and then dividing this sum by the total number of precious metal P atoms present in the catalyst.

Preferably, the weight percentage of the precious transition metal P is comprised between 0.1% and 4.0%, preferably between 0.2% and 2%, with respect to the weight of said P/Metal-N—C type hybrid catalyst according to the invention.

Advantageously, the weight percentage of the precious transition metal is comprised between 0.2 and 2.0% with respect to the weight of the P/Metal-N—C type hybrid catalyst according to the invention. Thus, this corresponds to an amount comprised between 8 and 80 micrograms of precious transition metal per square centimeter of electrode for an electrode loaded with 4 milligrams per square centimeter of P/Metal-N—C type hybrid catalyst. An amount comprised between 8 and 80 micrograms of precious transition metal per square centimeter of electrode is smaller than the threshold of 0.1 milligrams of platinum per square centimeter which is the threshold value adopted by the automotive industry for the next generation of cathode catalysts for PEMFCs.

Hence, in the P/Metal-N—C type hybrid catalyst according to the invention, the amount of precious transition metal is much smaller than that comprised by the catalysts of the related art such as:
the P/Metal-N—C type hybrid catalysts which comprise a precious transition metal in a metallic form (this metallic form of the precious transition metal in these hybrid catalysts is due to the fact that the precious transition metal salts that have been used as raw materials of these hybrid catalysts have been completely reduced during the manufacture of said hybrid catalysts) or
the catalysts based on precious transition metals or on metallic alloys of a precious transition metal with various transition metals (for example a Pt₃M type alloy of platinum, where M is a transition metal such as iron, cobalt or nickel),

in which the oxygen reduction reaction takes place at the surface of the precious transition metal. For example, in the Pt₃M type catalysts, 75% of the metal atoms consist of platinum atoms. In these catalysts of the related art, the electrochemical activity is inherent to the electrochemical activity of the precious transition metals that they comprise such as platinum.

The reduced amount of precious transition metal in the P/Metal-N—C type hybrid catalyst according to the invention has the advantage of reducing by about 20 to 30% the total cost of the PEMFC in which it is integrated (this percentage depends on the cost of the precious transition metal), and this while ensuring a greater durability of said catalyst according to the invention in comparison with the Metal-N—C type catalysts.

For example, a Pt/Fe—N—C hybrid catalyst according to the invention (namely the non-precious transition metal is iron and the precious transition metal is platinum) whose weight percentage of platinum is 1.0% is completely stable during at least 80 hours of operation in a PEMFC and the energy density is 0.12 g of platinum per kW, that is to say close to the target threshold of 0.1 g of platinum per kW.

The non-precious transition metal atoms corresponding to the most active catalytic sites for dioxygen reduction in the P/Metal-N—C type hybrid catalyst according to the invention are scattered in an atomic fashion over said nitrogen-doped carbonaceous matrix. These catalytic sites are hereinafter called «MetalN_{X}C_{Y} active sites». The index x indicates the number of nitrogen atoms present in the first coordination sphere around the central non-precious transition metal atom and which are bonded by a chemical bond to the latter, whereas the index y indicates the number of carbon atoms present in the second coordination sphere around the central transition metal atom. These carbon atoms are either (i) bonded by a chemical bond to at least one nitrogen atom belonging, in turn, to the first coordination sphere around the metal, or (ii) located at a radial distance from the non-precious metal atom which is equivalent to the radial distance between the metal atom and the carbon atoms defined in (i).

The scattering of the non-precious metal atoms at the atomic level (no chemical or physical bonds between two non-precious metal atoms) in the form of ions stabilized by chemical bonds with nitrogen and/or carbon atoms is responsible for the catalytic activity of the P/Metal-N—C type hybrid catalyst according to the present invention. This scattering at the atomic level may be demonstrated:
by X-ray absorption spectroscopy: absence of any signal corresponding to the Metal-Metal interactions for the metallic particles (zero oxidation state of the metal), metal carbides, metal oxides, of the non-precious transition metals, such as iron and cobalt,
where appropriate, for the Fe—N—C catalysts, by Mössbauer ⁵⁷Fe spectrometry: absence of sextets and singlets characteristic of iron carbides, iron oxides and metallic iron (zero oxidation state) in the Mössbauer spectrum.

Besides being scattered atom-by-atom within the nitrogenous carbon matrix, the non-precious metal atoms in the catalysts of the present invention are located at the surface of the nitrogenous carbon matrix, and not within the mass of this matrix. This surface positioning of the metal ions can be checked by X-ray absorption spectroscopy in «operando», that is to say by measuring a series of X-ray absorption spectra of a Metal-N—C catalyst electrode immersed into an acid electrolyte and corresponding to a series of electrochemical potentials (electric potential difference between the surface of the catalyst and the electrolyte) applied at the electrode. The modification of the X-ray absorption spectra around the iron threshold with the electrochemical potential applied at the electrode, and the overlapping of the different spectra at points called isosbestic points demonstrates that the MetalNₓC_{y} sites are located at the surface of the nitrogen-doped carbon matrix. Hence, thanks to the atom-by-atom scattering and the surface positioning of the MetalNₓC_{y} sites, the use of the non-precious metal atoms for the oxygen reduction catalytic reaction is maximized.

However, in the P/Metal-N—C type hybrid catalyst according to the invention, a fraction of the non-precious transition metal atoms may also be present in the form of metallic particles or metallic carbides. These crystalline phases of the non-precious transition metal may be produced in parallel with the MetalNₓC_{y} active sites, during the synthesis at high temperature of the Metal-N—C catalyst which is a starting constituent of the P/Metal-N—C type hybrid catalyst according to the invention.

The non-precious transition metal may be selected from titanium, vanadium, chromium, manganese, nickel, copper, iron and cobalt, considered alone or mixed with the latter or in the form of an alloy of non-precious transition metals. Preferably, it consists of iron and cobalt.

The precious transition metal may be selected from ruthenium, rhodium, palladium, silver, gold, rhenium, osmium, iridium, platinum and cerium, considered alone or mixed with the latter or in the form of an alloy with at least one precious or non-precious transition metal. Preferably, it consists of platinum.

Preferably, the precious transition metal is in the form of nanoparticles. Advantageously, the size of said nanoparticles is comprised between 1 nm and 10 nm, preferably between 2 nm and 4 nm, and still more preferably between 1 nm and 2 nm.

The P/Metal-N—C type hybrid catalyst according to the invention comprises micropores (namely pores having a size smaller than 20 Ångström) and/or mesopores (namely pores having a size comprised between 20 and 500 Ångström) in which lie the nanoparticles of the precious transition metal.

The specific surface generated by the different types of pores may be greater than 300 m² g⁻¹. In an embodiment of the invention, said specific surface is comprised between about 100 m² g⁻¹ and about 1600 m² g⁻¹.

The precious transition metal may be scattered in a homogeneous manner and located in the proximity of the MetalNₓC_{y} active sites of the P/Metal-N—C type catalyst according to the invention.

In the context of the present invention, by «located in the proximity of», is meant that, if we consider a representative non-precious transition metal based catalytic center (in other words a MetalNₓC_{y} active site), the closest precious transition metal particle to said MetalNₓC_{y} active site is located at a distance smaller than 50 nm, preferably at a distance smaller than 20 nm.

The particles of the partially oxidized precious transition metal chemically decompose the radical species produced during the reduction of dioxygen by these active sites into compounds inoffensive to the catalyst and the electrolyte such as water and dioxygen.

This catalytic function of the partially oxidized precious transition metal particles is different from that of the precious transition metal particles used up to now in the P/Metal-N—C type hybrid catalysts or in the precious transition metal based non-hybrid catalysts.

In these catalysts of the related art, the precious transition metal atoms are in their reduced form (namely at a zero oxidation state) inside the precious transition metals particles, which confers an electro-catalytic property both for the electrochemical reduction of dioxygen and for the electrochemical reduction of hydrogen peroxide. For example, the metallic platinum at zero oxidation state is known to be the most active catalyst for the electro-reduction of hydrogen peroxide.

In the P/Metal-N—C type hybrid catalyst according to the invention, the decoupling of the catalytic functions:
of dioxygen electro-reduction ensured by the MetalNₓC_{y} active sites, and
of chemical decomposition of the radical species, ensured by the partially oxidized precious transition metal particles,

allows reducing significantly the amount of precious transition metal in comparison with that of the catalysts of the related art, while preserving a good catalytic activity in dioxygen reduction and while ensuring a good stability of said catalyst according to the invention.

In addition, the P/Metal-N—C type hybrid catalyst according to the invention is less sensitive, and even insensitive to the chemical substances known to be poisons for the precious transition metal surfaces (for example the halides ions and the carbon monoxide for platinum), thanks to the partially oxidized state of the precious transition metal particles in the catalyst according to the invention and the known insensitivity of the non-precious transition metal based active sites (namely the MetalNₓC_{y} active sites) to these chemical substances.

In the P/Metal-N—C type hybrid catalyst according to the invention, the precious transition metal is used as a stabilizer of the MetalNₓC_{y} active sites for the reduction of dioxygen during the operation of the electrochemical device.

This is why, unlike the P/Metal-N—C type hybrid catalysts known in the related art, in the catalyst according to the invention, the precious transition metal that it comprises does not contribute to the catalytic activity for the dioxygen reduction of said catalyst, but it protects the non-precious transition metals based active sites (namely the MetalNₓC_{y} active sites) of these catalysts over time and during the operation of the electrochemical device. The catalytic function of reduction of dioxygen into water is ensured only by the MetalNₓC_{y} active sites.

In addition, unlike the precious transition metal based non-hybrid catalysts and the P/Metal-N—C type hybrid catalysts known in the related art where the precious transition metal atoms located inside the precious transition metal particles are in a zero oxidation state, in the P/Metal-N—C type hybrid catalyst according to the invention, the precious transition metal atoms that it comprises are in a partially oxidized state, and this even inside the precious transition metal particles. This confers to the P/Metal-N—C type hybrid catalyst according to the invention a spectroscopic signature of the precious transition metal clearly distinct from that of the precious transition metal located in the precious transition metal based non-hybrid catalysts or the P/Metal-N—C type hybrid catalysts known in the related art for dioxygen reduction. In this respect, the chemical state and the structural environment around the platinum atoms in a Pt/Fe—N—C hybrid catalyst according to the invention have been studied by X-ray absorption spectrometry at the absorption threshold L₃ of platinum and the results are detailed in the following experimental part.

The P/Metal-N—C type hybrid catalyst according to the invention also has technical characteristics related to its manufacturing method.

This is why, the present invention also concerns a P/Metal-N—C type hybrid catalyst which can be obtained by a manufacturing method which comprises at least the following steps of:

a) providing a Metal-N—C type hybrid catalyst,

b) impregnating said Metal-N—C type hybrid catalyst with at least one solution of a salt of a precious transition metal P so as to obtain a homogenous mixture,

c) performing at least one heat treatment on the homogenous mixture obtained at step b), said heat treatment consisting of a heating at a temperature comprised between 0 and 700° C., preferably between 100° C. and 700° C., in an inert or reducing (preferably slightly reducing) atmosphere so as to obtain a P/Metal-N—C type hybrid catalyst in which said precious transition metal P is partially oxidized (in other words reduced only partially with regards to its initial oxidation state as a metal salt, or said otherwise, partially oxidized with an average oxidation state greater than zero in the final hybrid catalyst), the concentration of the solution of the salt of the precious transition metal P being selected in a determined manner such that the weight percentage of said precious transition metal P is lower than or equal to 4.0%, preferably lower than or equal to 2.0%, with respect to the weight of the P/Metal-N—C type hybrid catalyst obtained upon completion of step c).

The concentration of said solution of precious transition metal salt may be selected in a determined manner such that the weight percentage of the precious transition metal is comprised between 0.1% and 4.0%, preferably between 0.2% and 2%, with respect to the weight of the P/Metal-N—C type hybrid catalyst obtained upon completion of step c), namely the catalyst according to the invention.

The determination of the concentration of the solution of the precious transition metal salt for obtaining a P/Metal-N—C type hybrid catalyst according to the invention for which the weight percentage of the precious transition metal is located within the intervals as described hereinabove and is perfectly within the reach of those skilled in the art.

Indeed, depending on the desired weight content of the precious transition metal in the P/Metal-N—C type hybrid catalyst according to the invention, those skilled in the art would prepare without any difficulty the solution of the precious transition metal salt at a determined concentration (in other words at an appropriate concentration).

The Metal-N—C type catalyst provided at step a) may have been obtained through a pyrolytic process or through an organic synthesis.

For example, the organic synthesis may be carried out by grafting in a covalent manner non-precious transition metal based macrocycles at the surface of a carbonaceous matrix or any other electronically-conductive support.

A macrocycle is either a cyclic macromolecule or the cyclic portion of a macromolecule, or an organic or organometallic molecule with an insufficient molecular weight for defining it as a macromolecule (by macromolecule, is meant a molecule which contains at least about 1000 atoms) but which contains a large cyclic structure (typically, a cycle of 15 atoms or more). Among the most known synthetic organometallic macrocycles, mention may be made to metal phthalocyanines and metal porphyrins. Among the molecules existing in biology and containing macrocycles involving a non-precious transition metal, mention may be made to vitamin B 12 (a cycle around a CoN₄ central pattern) or still metalloproteins which contain the heme substructure (a heme is an iron porphyrin, and contains a cycle of atoms around a FeN₄ central pattern).

Electronically-conductive supports, partially carbonated or completely non-carbonated, and suitable for a use in an electrochemical appliance are, for example, metals carbides (titanium carbide, tungsten carbide), oxides (titanium oxide, tin oxide, tungsten oxide, molybdenum oxide). Some of these oxides are low electronic conductors but may be doped with a second metallic element, which increases their electronic conductivity. One of the most commonly used metals for doping the above-mentioned oxides is antimony.

The pyrolysis may be carried out in an inert or reducing atmosphere in the presence of organic or organometallic precursors and of salts of non-precious transition metals.

In an embodiment of the invention, the Metal-N—C type catalyst has been obtained upon completion of a pyrolysis at 1050° C. under argon for one hour of the precursors of said Metal-N—C type catalyst.

The manufacture of a Metal-N—C type catalyst through a pyrolytic process or through an organic synthesis is perfectly within the reach of those skilled in the art.

Step b) may be carried out at ambient temperature and under atmospheric pressure.

Preferably, at step b), the solution of precious transition metal salt is a solution of a platinum salt. For example, it may consist of a solution of a platinum salt of formula [Pt(NH₃)₄]Cl₂*H₂O with 99% purity, commercialized by the company INTERCHIM and which has been dissolved in water.

In an embodiment of the invention, the heat treatment of step c) consists of a heating for 2 hours at 560° C. in an atmosphere comprising a mixture of dihydrogen and dinitrogen (for example 5% of dihydrogen and 95% of dinitrogen expressed in molar percentages).

In an embodiment of the invention, the heat treatment of step c) is carried out at a temperature comprised between about 300° C. and about 600° C., for a time period comprised between about 15 minutes and about 2 hours, in an electrically-heated furnace.

The heat treatment may be carried out in:
a so-called «conventional» furnace, namely a furnace which heats up by electrical energy dissipation in resistances,
a furnace whose functioning is based on electromagnetic radiations, such as microwave furnaces or lamp furnaces.

The sufficient duration of the heat treatment is determined according to the heat appliance selected for performing this step c).

During the heat treatment, the atmosphere is inert (for example dinitrogen or argon) or reducing, preferably slightly reducing (for example dihydrogen, ammonia or a mixture of these two reducing gases with an inert gas).

When the atmosphere is reducing and comprises a mixture of inert gases (for example dinitrogen, argon, helium) and reducing gases (for example dihydrogen, methane, propane, acetylene), the reduction state of the precious transition metal salt is controlled mainly by the molar percentage of the reducing gas present in said gas mixture.

When the atmosphere is inert, the salt reduction state is controlled by secondary parameters other than the nature of the atmosphere, such as the pyrolysis temperature and/or the pyrolysis duration.

Advantageously, during the heat treatment, the atmosphere consists of a gaseous mixture containing between 2 mol % and 20 mol % of a reducing gas, so that the heat treatment duration required to partially reduce the salt of the precious transition metal is neither too long (which would be expensive) nor too short (which would pose problems because of the short time limitation of the heating appliance, in particular for furnaces heated by electric resistance).

In an embodiment of the invention in which a Pt/Fe—N—C type hybrid catalyst is obtained which comprises partially oxidized platinum nanoparticles with an average oxidation state of the platinum atoms comprised between 0.5 and 2.5, the heating apparatus used for the heat treatment of step c) includes a split-hinge tube furnace of the company THERMCRAFT (model Express-line, 1 heating area), a quartz tube with a diameter of about 4 cm and a quartz nacelle.

The powder of the Pt/Fe—N—C type hybrid catalyst precursor (namely a [Pt(NH₃)₄Cl₂*H₂O salt, mixed beforehand with a Fe—N—C type catalyst such that the weight content of platinum in said Pt/Fe—N—C type hybrid catalyst is 1%) is deposited into the quartz nacelle, and the quartz tube comprising the nacelle is connected to dinitrogen.

After the evacuation of air in the quartz tube by the dinitrogen flow, the tubular furnace (sill under the dinitrogen gaseous flow) comprising the quartz tube and the nacelle is heated up, at an average rate of 4° C. per minute, up to the temperature of 560° C., and then kept for 2 hours at the temperature of 560° C. under the flow of a gaseous mixture comprising 5% of dihydrogen and 95% of dinitrogen expressed in molar percentages. Afterwards, the tubular furnace is opened, the quartz tube is removed from the heating area, and it cools down naturally at ambient temperature under a dinitrogen flow.

Optionally, the manufacturing method further comprises a step of cooling the P/Metal-N—C type hybrid catalyst obtained upon completion of step c).

Upon completion of the manufacturing method, a P/Metal-N—C type hybrid catalyst with a large specific surface is obtained, and at the surface of which particles of a precious transition metal have been deposited. The large specific surface of the hybrid catalyst is generated by micropores and mesopores in which the particles of the precious transition metal are integrated. Preferably, the precious transition metal particles consist of nanoparticles as described hereinabove.

The present invention also concerns a P/Metal-N—C type hybrid catalyst which can be obtained by a manufacturing method slightly different from that described hereinabove and which comprises at least the following steps of:

i. mixing precursors of a Metal-N—C type catalyst with at least one solution of a salt of a precious transition metal P so as to obtain a homogenous mixture,

ii. performing at least one heat treatment on the homogenous mixture obtained at step i), said heat treatment consisting of a heating at a temperature comprised between 500 and 1100° C. in an inert or reducing atmosphere so as to obtain a P/Metal-N—C type hybrid catalyst in which said precious transition metal P is partially oxidized,

the concentration of the solution of the salt of the precious transition metal P being selected in a determined manner such that the weight percentage of said precious transition metal P is lower than or equal to 4.0%, preferably lower than or equal to 2.0%, with respect to the weight of the P/Metal-N—C type hybrid catalyst obtained upon completion of step ii).

The concentration of said solution of a precious transition metal salt may be selected in a determined manner such that the weight percentage of the precious transition metal is comprised between 0.1% and 4.0%, preferably between 0.2% and 2%, with respect to the weight of the P/Metal-N—C type hybrid catalyst according to the invention.

The determination of the concentration of the precious transition metal salt for obtaining a P/Metal-N—C type hybrid catalyst according to the invention for which the weight percentage of the precious transition metal is located within the intervals as described hereinabove and is perfectly within the reach of those skilled in the art.

The characteristics of step ii) of this 2^{nd} manufacturing method may be identical to those of the 1^{st} manufacturing method described hereinabove.

Another object of the present invention is an electrochemical device which comprises at least one P/Metal-N—C type hybrid catalyst according to the invention as described hereinabove.

Advantageously, said electrochemical device is selected from metal-air batteries, fuel cells operating at low temperature, for example PEFMCs.

In an embodiment of the invention, the electrochemical device is a device in which the electrochemical reaction at the cathode consists of oxygen reduction. The cathode is said depolarizing.

The invention will be better understood from the detailed description which follows, with reference to the appended drawing representing, as a non-limiting example, the experimental results obtained from P/Fe—N—C type hybrid catalysts according to the invention and compared with those obtained with catalysts of the related art.

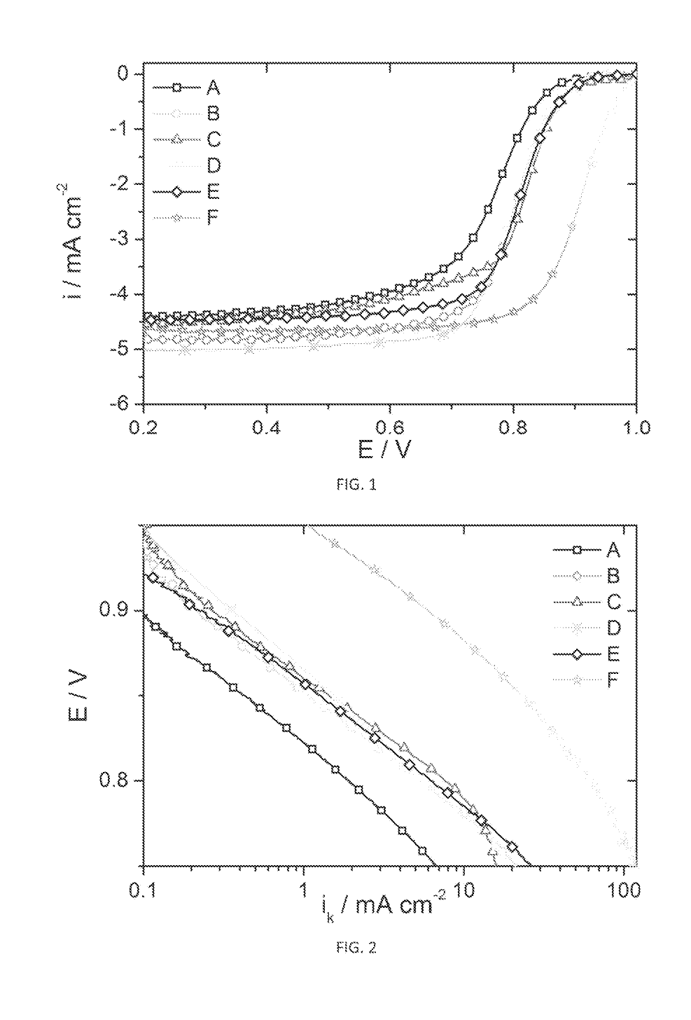

FIG. 1 represents polarization curves of the dioxygen reduction at the rotating disk electrode for 6 catalysts.

FIG. 2 represents the kinetic portion of the curves presented in FIG. 1, after correction of the curves for the limitation due to the diffusion of dioxygen in an acid electrolyte, using the Koutecky-Levich equation.

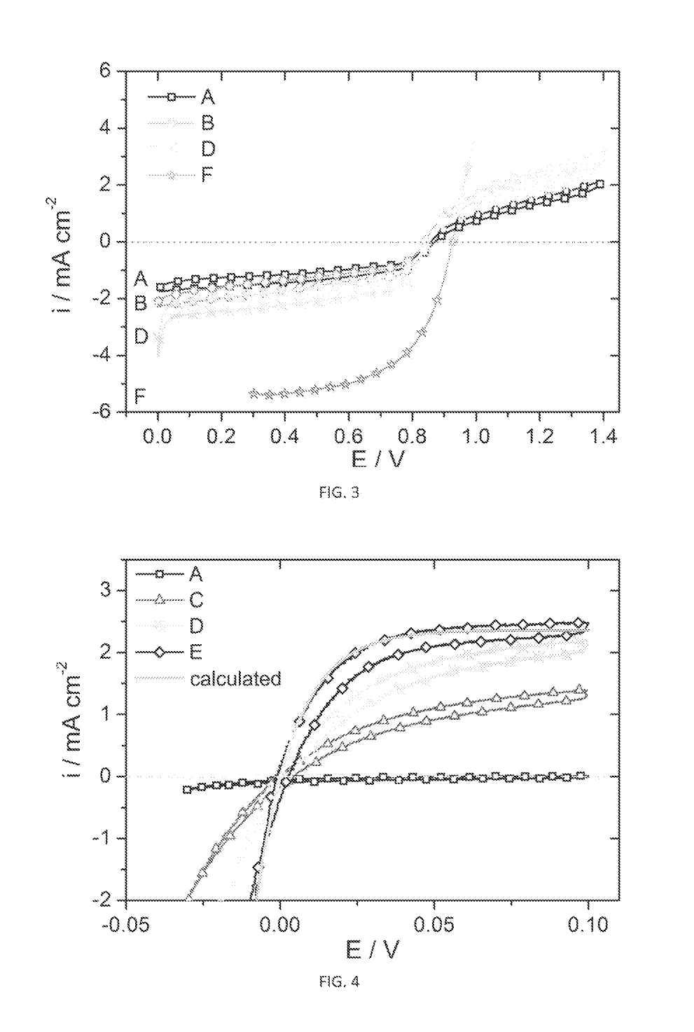

FIG. 3 represents the polarization curves of the reduction (the current i being lower than 0) and of the oxidation (the current i being higher than 0) of hydrogen peroxide at the rotating disk electrode for 4 of the tested catalysts.

FIG. 4 represents the polarization curves of the reduction of protons into dihydrogen (the current i being lower than 0) and of the oxidation of dihydrogen into protons (the current i being higher than 0) at the rotating disk electrode for 4 of the tested catalysts.

FIG. 5 represents the polarization curves in PEMFC for 5 of the tested catalysts.

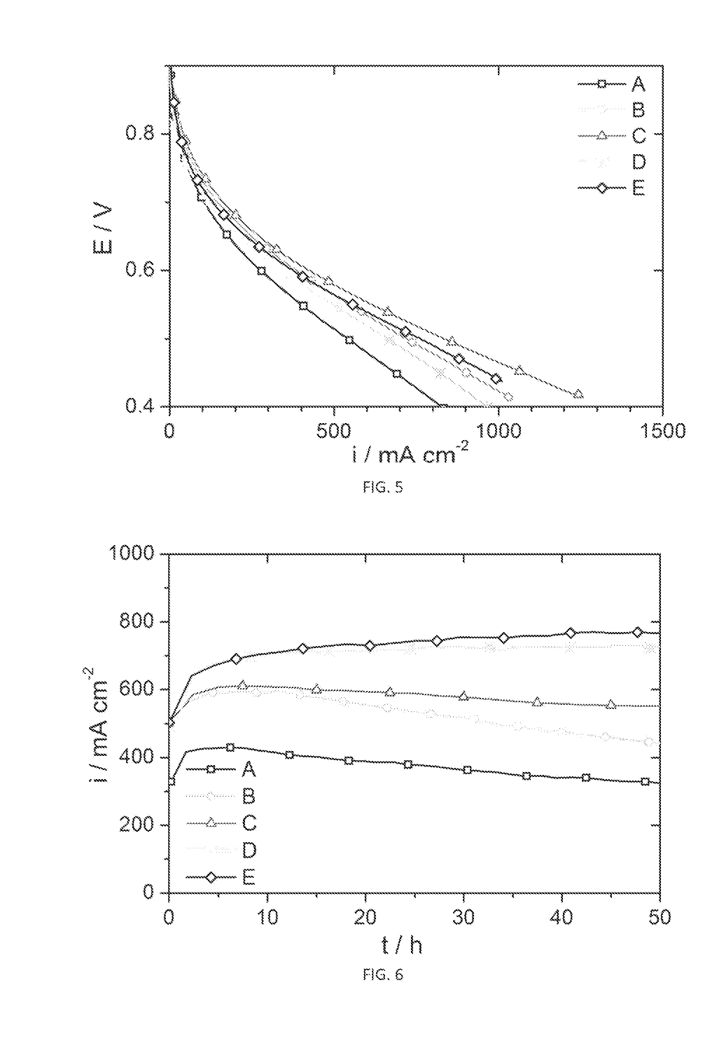

FIG. 6 represents the current density as a function of time with a PEMFC potential set to 0.5 V for 5 of the tested catalysts.

FIG. 7 represents the polarization curves, after correction in order to take into account the ohmic resistance of the membrane, and that after 50 hours of operation of the PEMFC at 0.5 V for 5 of the tested catalysts.

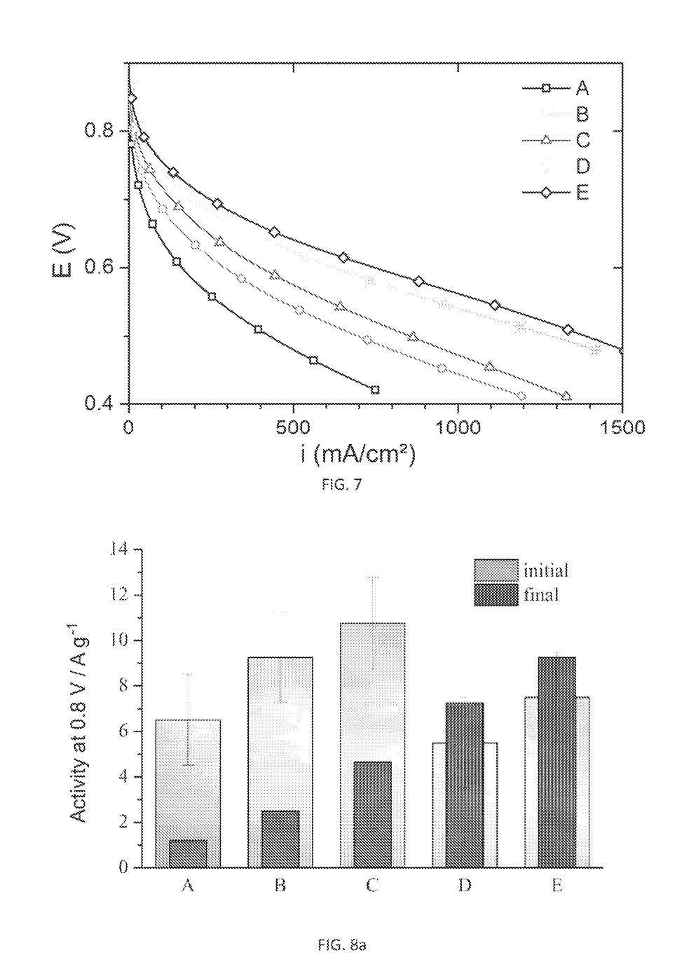

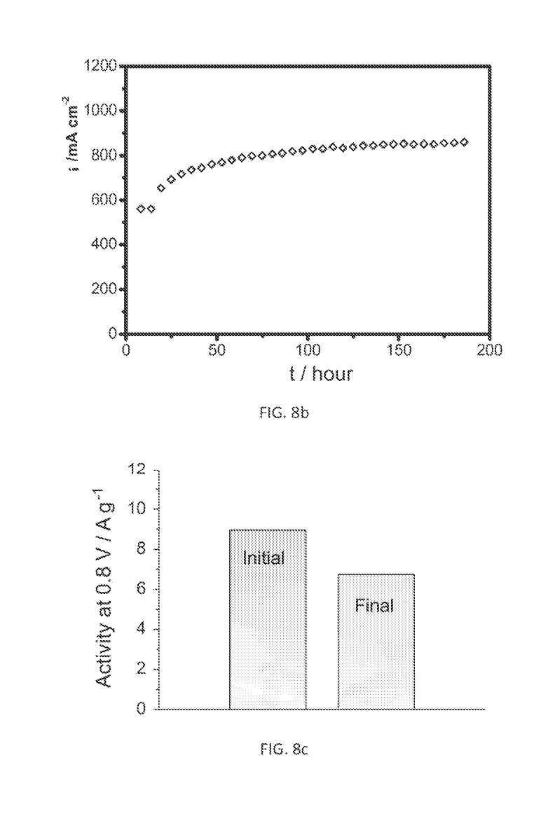

FIG. 8a represents the activity for the dioxygen reduction reaction at 0.8 V in cell, before and after 50 hours of operation of the PEMFC at 0.5 V for 5 of the tested catalysts.

FIG. 8b represents the current density as a function of time with a PEMFC potential set to 0.5 V for the tested catalyst E over a time period of 200 hours.

FIG. 8c represents the catalytic activity at a PEMFC potential set to 0.8 V for the tested catalyst E, before and after 200 hours of operation of the PEMFC at a potential of 0.5 V.

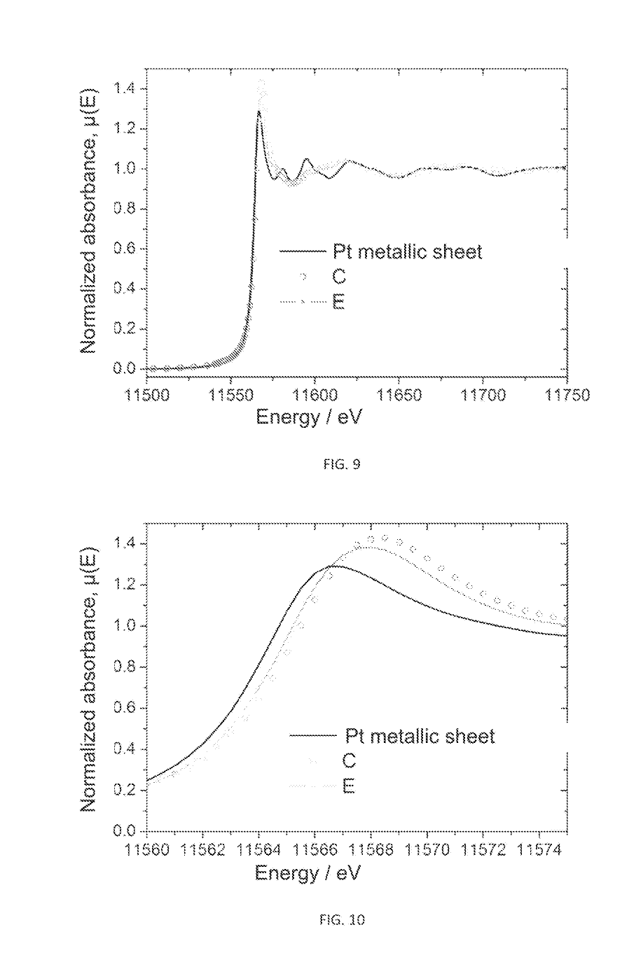

FIG. 9 represents the X-ray absorption spectra around the absorption threshold L₃ of platinum of the catalysts C and E and of a platinum metallic sheet.

FIG. 10 represents an enlargement of the spectra of FIG. 9 around the absorption threshold L₃ of platinum.

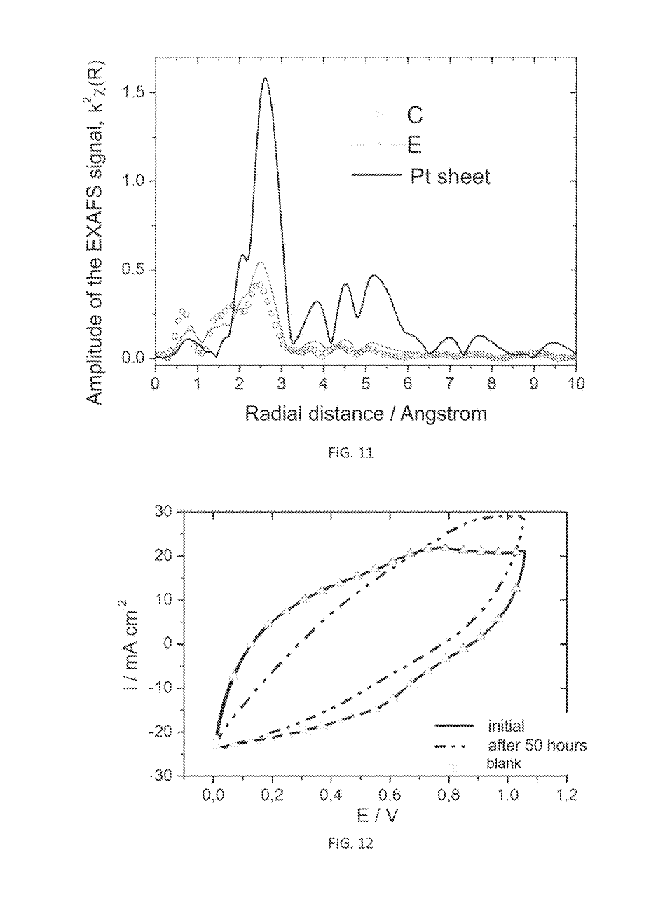

FIG. 11 is a graph of the Fourier transform of the X-ray absorption signal in fine structure (hereinafter abbreviated as «EXAFS») of the platinum of the catalysts C and E according to the invention in comparison with the Fourier transform of the EXAFS signal of the platinum of the platinum metallic sheet.

FIG. 12 represents curves of an electrochemical detection test of carbon monoxide, a probe molecule well known for characterizing metallic platinum particles (platinum atoms having a zero oxidation state inside the particle); and the comparison of such curves before and after a 50 hour test in a PEMFC cell at 0.5 V carried out with the catalyst D.

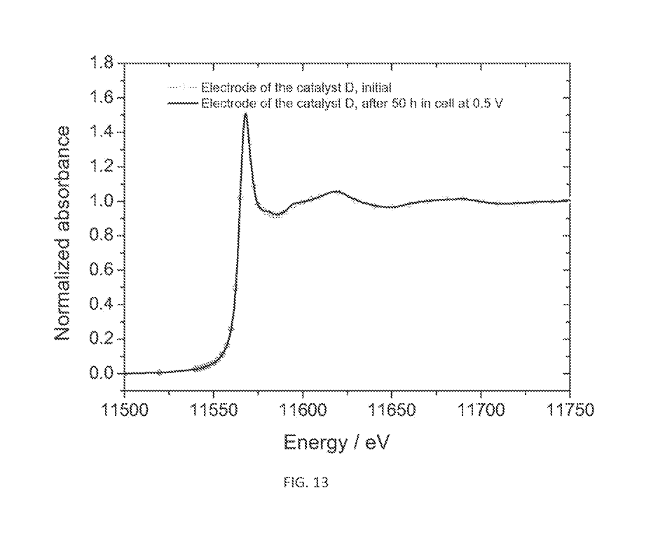

FIG. 13 represents the X-ray absorption spectra around the absorption threshold L₃ of platinum of the catalyst D, before and after a test in cell at 0.5 V for 50 hours.

The following experimentations have been carried out so as to compare the properties and the performances of three hybrid catalysts according to the invention with respect to those of precious transition metal based catalysts known in the related art.

The technical characteristics of the tested catalysts were as follows:
catalyst A: Fe—N—C type catalyst, namely a catalyst comprising a nitrogen-doped carbonaceous matrix and on which iron atoms are bonded in a covalent manner;
catalyst B: the catalyst A which has been subjected to a heat treatment detailed hereinafter. This treatment had the effect of increasing the specific surface of the catalyst B with respect to that of the catalyst A. This catalyst B was the platinum-free Fe—N—C «reference» catalyst;
catalyst C: 1^{st} catalyst according to the invention which has been obtained after post-functionalization of the catalyst A. The post-functionalization has consisted of the same heat treatment as that of the catalyst B but with the additional presence of a metallic platinum salt which has been reduced. The weight content of platinum in the catalyst C was 0.5% with respect to the total weight of the catalyst C;
catalyst D: 2^{nd} catalyst according to the invention which has been obtained after post-functionalization of the catalyst A. The post-functionalization has consisted of the same heat treatment as that of the catalyst B but with the additional presence of a platinum salt which has been partially reduced. The weight content of platinum in the catalyst D was 1.0% with respect to the total weight of the catalyst D;
catalyst E: 3^{rd} catalyst according to the invention which has been obtained after post-functionalization of the catalyst A. The post-functionalization has consisted of the same heat treatment as that of the catalyst B but with the additional presence of a platinum salt which has been partially reduced. The weight content of platinum in the catalyst E was 2.0% with respect to the total weight of the catalyst E;
catalyst F: a Pt/C type commercial catalyst, namely a catalyst comprising a carbonaceous matrix and on which platinum nanoparticles have been synthesized. The weight percentage of platinum was 46% with respect to the total weight of the catalyst F. This catalyst is commercialized by the Japanese company Tanaka Kikinzoku.

The precursor of the Fe—N—C type catalyst A has been manufactured in a planetary mill from:
a crystalized porous hybrid solid comprising Zn(II) cations and methyl-imidazolate ligands, of formula ZnN₄C₈H₁₂, commercialized by the company BASF under the commercial name Basolite® Z1200, abbreviated hereinafter as «ZIF-8»,
a Fe(II) salt, namely non-hydrated iron acetate,
a second nitrogenous ligand for the Fe(II) ions, namely 1,10-phenanthroline.

The dry powders of ZIF-8, of iron salt and of phenanthroline have been weighted into the desired proportions and then deposited into a zirconium oxide crucible. The catalyst precursor before grinding contained 1 weight % of iron and the weight ratio of phenanthroline on ZIF-8 was 20/80. Afterwards, 100 balls of zirconium oxide with a diameter of 5 mm have been added into the crucible which has been sealed and disposed into a planetary mill commercialized by the company FRITSCH under the commercial name Pulverisette 7 Premium®. 4 cycles of 30 minutes at a speed of 400 rpm have been performed in order to mix the powders. The catalyst A precursor obtained accordingly has been pyrolyzed at 1050° C. under argon for one hour so as to obtain the catalyst A.

The hybrid catalysts C to E according to the invention have been obtained in the following manner:

300 mg of the catalyst A have been impregnated with a solution of a platinum salt, namely a platinum salt of formula [Pt(NH₃)₄]Cl₂*H₂O with 99% purity, commercialized by the company INTERCHIM, which was dissolved in water.

To do so, for each of the catalysts C to E, a total of 550 μL of the platinum salt solution has been poured, per portion of 100 μL, on the catalyst powder, while pounding the mixture obtained accordingly with a mortar between each pour of 100 μL. At the end of the impregnation, the obtained mixture presented a slightly muddy aspect which is characteristic of a complete filling of the pores of the Fe—N—C type catalyst A by the platinum salt solution.

In order to obtain the contents by weight of the catalysts C to E detailed hereinabove, the concentration of the platinum salt solution has been appropriately adjusted.

The impregnated samples obtained accordingly have been dried in an oven under air for 2 hours at 80° C.

The powder that has been obtained upon completion of this drying has been disposed into a quartz nacelle which has in turn been placed into a quartz tube. The set has been introduced into a tubular furnace in order to undergo a heat treatment consisting of a heating for 2 hours at 560° C. in an atmosphere comprising a mixture of dihydrogen and dinitrogen (5% of dihydrogen and 95% of dinitrogen, expressed in molar percentages).

Afterwards, upon completion of the heat treatment, the powder has been cooled in a dinitrogen atmosphere.

The catalyst B has been prepared from a catalyst A which has not been impregnated with the platinum salt solution but has undergone this same heat treatment and this cooling step detailed hereinabove.

The specific surface of the catalysts A to E has been determined by dinitrogen adsorption and by analysis of the adsorption isotherm with the Brunauer-Emmett-Teller equation.

Table 1 hereinbelow details the specific surface of the catalysts A to E measured by dinitrogen adsorption, as well as the surface increase percentage of the catalysts B to E with respect to the surface of the catalyst A, in other words the increase percentage of the surface after the heat treatment detailed hereinabove.

TABLE 1
specific surface of the catalysts A to E and relative increase of the
specific surface of the catalysts B to E after the heat treatment

| | surface in | % of surface |
|---|---|---|
| catalyst | m²/g | increase |
| A | 370 | 0 |
| B | 520 | 40 |
| C | 560 | 51 |
| D | 530 | 43 |
| E | 550 | 49 |

As seen in Table 1, we note that the heat treatment has considerably increased the surface of the catalysts and that the amount of platinum has not had any great influence on the increase of the surface, as demonstrated by the catalyst B (without platinum). Thus, only the heat treatment under dihydrogen/dinitrogen has induced an increase of the surface of the catalysts.

Catalytic films comprising the catalysts A to E have been deposited over the rotating disk electrodes in the following manner:

A catalytic ink has been prepared with 10 mg of the concerned catalyst, 108 μL of a Nafion® solution (5 weight % of Nafion® polymer scattered into an alcohols based solution) commercialized by the company DuPont, 300 μL of ethanol with 99% purity commercialized by the company API France and 36 μL of ultra-pure water. The catalytic ink has been homogenized in an ultrasonic bath for at least 30 minutes. Afterwards, 7 μL of this ink have been deposited over a disk with a diameter of 5 mm made of glossy carbon so as to obtain a rotating disk electrode with a catalytic film whose catalyst load was 800 μg/cm².

For each of the tested electrodes, the catalyst total load was 800 μg/cm².

Hence, the platinum content at the electrode comprising:
the catalyst C was 4 μg/cm²
the catalyst D was 8 μg/cm²
the catalyst E was 16 μg/cm².

As regards the electrode comprising the catalyst F, the platinum load at this electrode was 20 μg/cm². To do so, 1.4 mg of the catalyst F have been scattered into 3 mL of water by an ultrasonic treatment, and 20 μL have been deposited onto a glassy carbon electrode tip and dried under air.

The electrochemical device comprising the rotating disk electrode further included:
a glass cell,
a pH1 acid electrolyte containing HClO₄ at a concentration of 0.1 mol/L,
a carbon counter-electrode,
a hydrogen reference electrode (hereinafter abbreviated as «HRE»), constituted by a platinum wire immersed into a separate compartment and containing the same electrolyte but dihydrogen saturated, this compartment being connected in an electrolytic manner to the main compartment by a glass sinter,
a potentiostat commercialized by the company Princeton Applied Research under the commercial name Versastat®.

The experimental conditions of the device comprising the rotating disk electrode were as follows:
ambient temperature,
rotating speed of the electrode: 1600 rpm,
20 voltammetric cycles between 0.05 and 1.1 V relative to the HRE have been conducted in order to clean the rotating disk electrode.

Afterwards, the voltammetric cycles have been conducted between 0.2 and 1.0 VHRE at a scanning speed of 10 mV/s in the dinitrogen-saturated electrolyte, then in dioxygen, and the curves measured under dinitrogen have been subtracted from those measured under dioxygen, in order to eliminate the non-faradic currents (that is to say the currents not related to the dioxygen reduction, such as the capacitive current). In addition, the curves have been corrected for the ohmic drop in the electrolyte (a resistance of about 20 Ohms for this device).

In FIG. 1 are represented the polarization curves of the reduction of dioxygen obtained from a rotating disk electrode, and that with the tested catalysts A to F.

The curves of FIG. 1 indicate that the best catalyst for the reduction of dioxygen is the catalyst F. Indeed, the kinetics of the oxygen reduction reaction is shown around 0.9-1.0 V_{HRE}.

At a lower potential, the curve of the catalyst F shows a plateau in current which is not related to the electrochemical kinetics of the dioxygen reduction, but defined by:

i) the maximum possible diffusion flow of the dioxygen dissolved in the electrolyte toward the electrode (this depends on the rotating speed of the electrode) and by

ii) the selectivity of the catalyst for the dioxygen reduction reaction (the reduction of dioxygen essentially into water, but also the reduction of a few percentages of dioxygen molecules into peroxide instead of water).

The catalyst A has a kinetic portion of its polarization curve for the oxygen reduction reaction which is shifted toward the more negative potentials, at about −150 mV. This means less rapid kinetics. Nonetheless, the diffusion limit current at low potential is close to that of the catalyst F thereby indicating that the product of the dioxygen reduction reaction on the catalyst A is essentially water.

The catalyst B corresponds to the catalyst A which has been subjected to a heat treatment; which has resulted in increasing its surface. The activity of the catalyst B is higher by about 50 mV than that of the catalyst A and lower by about 100 mV than that of the catalyst F. The kinetic regime of the curves is located between 0 and −2 mA/cm². Its diffusion limit current is equal to that of the catalyst F thereby indicating a reduction of dioxygen into water essentially.

Considering the almost superimposition of the portions of the curves of the catalysts B to E between 0 and −2 mA/cm² (namely the kinetic regime), the three hybrid catalysts C to E according to the invention have an activity for the dioxygen reduction reaction which is almost identical to that of the reference catalyst B.

This reflects that the dioxygen reduction reaction catalysis function of the catalysts C to E according to the invention lies only in the catalytic surface of the Fe—N—C catalyst, obtained with the heat treatment, and not in the platinum salt that has been added before the implementation of the heat treatment.

Table 2 hereinbelow details for the catalysts A to E the activities per weight of catalyst at different potentials (namely at 0.8 V_{HRE}, 0.85 V_{HRE} and 0.9 V_{HRE}).

TABLE 2
detailing the activities per weight of the catalysts at different potentials

| catalyst | 0.8 V_{HRE} | 0.85 V_{HRE} | 0.9 V_{HRE} |
|---|---|---|---|
| A | 2.3 | 0.5 | 0.1 |
| B | 6.5 | 1.3 | 0.3 |
| C | 9.2 | 1.8 | 0.3 |
| D | 6.6 | 1.9 | 0.4 |
| E | 7.7 | 1.5 | 0.3 |

As seen in Table 2, by comparing the activities of the catalyst A with those of the catalysts B to E, we note that the heat treatment has had the effect of increasing 3 to 4 times the activity of the catalyst. This increase of the activity of the catalyst is to be correlated with the increase of the surface of the catalyst subsequently to the heat treatment mentioned hereinabove with the results of Table 1.

FIG. 2 represents the kinetic portion of the curves represented in FIG. 1, after correction of the curves so as to correct the limitation due to the diffusion of dioxygen, and that using the Koutecky-Levich equation.

The kinetics of the dioxygen reaction are determined by an exponential law between the current and the electrochemical potential, that is to say a line in on a semi-logarithmic scale E_{HRE} vs log(i).

FIG. 2 shows that:
the slopes of the curves are similar: which means that the mechanism of the dioxygen reduction reaction is similar for the different catalysts, but
the kinetics are different: the activity of the dioxygen reduction reaction can be quantified by collecting the current density at a given electrochemical potential, for example at 0.9 V vs HRE: about 6 mA/cm² for the catalyst F, 0.2 mA/cm² for the catalyst B and between 0.2 and 0.3 mA/cm² for the catalysts C to E.

This accurate quantification of the activity of the dioxygen reduction reaction allows demonstrating that platinum in the catalysts C to E according to the invention is not active for the dioxygen reduction reaction. Indeed, there is no significant increase of the activity of the catalyst C to E according to the invention with respect to that of the reference catalyst B.

Yet, despite the low weight content of platinum (namely: 0.5, 1 or 2%) in the catalysts C to E according to the invention, if the structure of the platinum particles in the catalysts according to the invention C to E was the same as that in the catalyst F (namely metallic platinum nanoparticles with a zero oxidation state), an increase of the activity of the catalysts C to E according to the invention with respect to that of said catalyst B would have been observed.

Indeed, the electrode comprising the catalyst F contains 20 μg of platinum per cm² and the electrode comprising the catalyst E contains an almost equivalent content of platinum, namely 16 μg/cm², and this considering that the size of the platinum nanoparticles in these two catalysts is similar, a similar activity of the dioxygen reduction reaction would have been observed between these two catalysts E and F. Yet, this has not been the case.

This reflects that the platinum contained in the hybrid catalysts C to E according to the invention is not therefore active for the dioxygen reduction reaction. Its structure is different from that of the metallic platinum contained in the catalyst F.

With this same experimental technique of the rotating disk electrode implementing the catalysts detailed hereinabove, the kinetics of the hydrogen peroxide reduction reaction have been studied.

FIG. 3 represents the polarization curves of the hydrogen peroxide reduction at the rotating disk electrode.

In these experimentations, the experimental conditions of the device comprising the rotating disk electrode were as follows:
pH 1 acid electrolyte containing HClO4 at a concentration of 0.1 mol/L dinitrogen-saturated and with a concentration of 3 mmol/L of hydrogen peroxide,
ambient temperature,
rotating speed of the electrode: 1600 rpm.

As seen in the curves of FIG. 3, it is observed that the catalyst F is very active:
for the electrochemical reduction reaction of hydrogen peroxide into water, and this considering the negative currents, as well as
for the electrochemical oxidation of the hydrogen peroxide into dioxygen, and this considering the positive currents,

with a zero-current potential of 0.9-0.95 V vs HRE, which is characteristic of a reduced platinum surface.

Conversely, the catalysts A, B and D are barely active for the hydrogen peroxide reduction and oxidation reactions. This is characteristic of the catalysts whose active sites are iron-based.

Thus, the curves of FIG. 3 also clearly reflect that the platinum structures that the catalysts according to the invention comprise do not consist of metallic platinum as that of the catalyst F. The platinum present in the catalysts according to the invention does not contribute to the electrochemical reduction of small amounts of hydrogen peroxide produced during the dioxygen reduction reaction.

Afterwards, a 3^{rd} catalytic function of the platinum present in the catalysts according to the invention has been studied, namely the electrochemical oxidation of dihydrogen. Indeed, in a PEMFC, a low flow of dihydrogen passes through the fine polymer membrane separating the anode and the cathode. Dihydrogen that has diffused through the membrane may chemically react with the dioxygen of the cathode so as to form extremely oxidant radical species such as ⁻OH and ⁻OOH. These radical species may attack the membrane or the catalyst.

This is why, using the same rotating disk electrode experimental technique, the kinetics of oxidation of dihydrogen into protons H⁺, and of reduction of protons H⁺ into dihydrogen has been studied.

FIG. 4 represents the polarization curves of the protons reduction and dihydrogen oxidation at the rotating disk electrode.

The experimental conditions of the device comprising the rotating disk electrode were as follows:
a pH 1 dihydrogen-saturated acid electrolyte containing HClO₄ at a concentration of 0.1 mol/L,
ambient temperature,
rotating speed of the electrode: 1600 rpm.

As seen in the curves of FIG. 4, we note that:
when using a catalyst F at the cathode, the small amount of dihydrogen that arrives from the anode to the cathode by diffusion through the membrane is immediately electro-oxidized into protons;
the catalyst A is completely inactive for this reaction (cf. the curve A in FIG. 4). This catalyst rather promotes a chemical reaction between dihydrogen and dioxygen for forming free radicals.

In FIG. 4, we note that the curve of the catalyst E according to the invention is almost superimposed with the theoretical curve (cf. the calculated curve) corresponding to infinite kinetics of the dihydrogen oxidation, meaning that the sole experimentally observable loss is due to the diffusion of the dihydrogen dissolved in the electrolyte toward the electrode, the kinetics being much faster than the diffusion that the kinetics cannot therefore be quantified by this experimental method.

The curves of FIG. 4 reflect that the platinum structures in the hybrid catalysts according to the invention are active for the dihydrogen oxidation reaction, and this considering the positive currents of FIG. 4, but also for the reduction of the protons into dihydrogen, and this considering the negative currents of FIG. 4.

As seen in FIG. 4, the catalyst A is completely inactive for the dihydrogen reduction and protons oxidation reactions. This inactivity toward dihydrogen and protons is a known property for the family of Fe—N—C and Co—N—C type catalysts.

The hybrid catalysts C to E according to the invention show a proportional increase of their catalytic activity for dihydrogen and protons H⁺ with the increase of the platinum content. This may be related to the better stabilization observed in PEFMC of the catalysts D and E according to the invention whose weight content of platinum is 1% and 2% respectively. Indeed, the catalysts A to E have also been tested in PEMFCs. This better stabilization is detailed hereinafter.

The initial polarization curves in PEMFC of the anode-membrane-cathode assemblies in which only the catalyst of the cathode (namely the tested catalysts A to E) vary are represented in FIG. 5.

The curves show the electric potential difference «cathode less anode» of the PEMFC as a function of the current density, and this after correction in order to take into account the ohmic resistance of the membrane.

Cathode catalytic inks have been prepared by mixing 20 mg of the concerned catalyst, 652 μL of a solution of 5 weight % of Nafion® containing 15-20 weight % of water, 326 μL of ethanol and 272 μL of deionized water. The inks have been homogenized by subjecting them alternately to ultrasounds and to a mechanical stirring in a vortex stirrer every 15 minutes, and this for a total time period of one hour.

Afterwards, 405 μL of catalyst ink have been successively deposited over a microporous later of a carbon tissue with a surface of 4.84 cm² commercialized by the company «SGL Group —The Carbon Company» under the commercial name SIGRACET® S10-BC so as to obtain a cathode comprising a catalyst load of 4 mg/cm².

The cathode has been disposed in a vacuum oven at 90° C. for one hour in order to be dried.

The anode contained a Pt/C type commercial catalyst whose platinum load was 0.5 mg/cm², pre-deposited over a microporous layer of the same carbon tissue, namely Sigracet S10-BC.

The anode-membrane-cathode assembly has been prepared by hot pressing at 135° C. for 2 minutes 4.48 cm² of the anode and of the cathode on either side of a membrane commercialized by the company DuPont under the commercial name Nafion® NRE-211.

The experimentations with the PEMFCs have been carried out in a commercial single-cell fuel cell comprising gas distribution channels in the form of a serpentine (the Fuel Cell Technologies company), using a PEMFC test bench within the laboratory, and by controlling the electric potential of the cell and the current produced with a commercial potentiostat of the company Biologic, coupled to a 50 A amplifier of the same company.

The experimental conditions were as follows:
cell temperature: 80° C.,
gas: dihydrogen and dioxygen humidified to 100% at a temperature of 85° C.,
relative pressure of the gases of 1 bar at the inlet of the anode and of the cathode,
gas flow of 50-70 cm³/minute for the humidified dioxygen and dihydrogen,
the polarization curves have been recorded at a scanning speed of 0.5 mV·s⁻¹.

As seen in FIG. 5, we note that the initial polarization curves for the catalysts B to E are almost identical. Indeed, the small differences are due to the reproducibility error in the synthesis of the catalysts and/or in the preparation of the anode-membrane-cathode assembly.

Initially, the catalysts B to E are more performant than the catalyst A, the initial current density at 0.5 V of the catalysts B to E being higher than that of the catalyst A by about 150 mA/cm². This is explained by the fact that the catalysts B to E have undergone a heat treatment. Thus, this reflects the effect of the heat treatment on the Metal-N—C type catalysts.

In order to test the mid-term stability of the hybrid catalysts C to E according to the invention for the dioxygen reduction reaction at the cathode, the potential difference of the PEMFC has been set to 0.5 V an the current density has been measured over 50 hours. This time period is sufficient to observe a decrease of the performances of the reference Fe—N—C catalyst, that is to say the catalyst B.

FIG. 6 represents the current density as a function of time for a PEMFC potential set to 0.5 V for 50 hours.

As seen in FIG. 6, we note that, in a reproducible manner, the Fe—N—C catalysts (catalysts A and B), are active during the first hours of operation of the PEFMC, and then exhibit a continuous degradation of the performances over time (about 20-25% of current loss with respect to the maximum observed after 3-6 hours).

The addition of platinum does not increase the initial performance at 0.5 V but stabilizes the hybrid catalysts (slighter slope for the hybrid catalyst C and no slope observable over 50 hours with the hybrid catalysts D and E according to the invention).

This shows that the platinum particles in the hybrid catalysts according to the invention should be advantageously present at a content high enough to effectively stabilize the Metal-N—C catalyst. The hybrid catalyst C according to the invention is not completely stable because of the low platinum content (namely 0.5%). This may be related to a much large average distance between any iron-based catalytic site and the closest platinum particle in this hybrid catalyst.

FIG. 7 represents the polarization curves corrected by taking into account the ohmic resistance of the membrane, measured after 50 hours of operation at 0.5 V of the PEMFC.

As seen in FIG. 7, we note that at a low electric potential, the polarization curves corresponding to the catalysts D and E are better after the 50 hour test than before the 50 hour test. This is due to an improvement of the transport properties of the species (dioxygen, water, protons) in the cathode, whereas the catalytic activity at 0.8 V is not or is barely modified as reflected by FIG. 8 described hereinafter.

FIG. 8a represents the activity for the dioxygen reduction reaction at 0.8 V in PEMFC, before and after the 50 hour test.

Considering the reproducibility error in the measurements, the initial activities of the dioxygen reduction reaction for the catalysts B to E are almost identical.

In addition, we note that, for each catalyst, the final activity of the dioxygen reduction reaction is more and more close to the initial activity as the platinum content of the hybrid catalysts C to E increases. This reflects that the low platinum content that the hybrid catalysts according to the invention comprise has the effect of stabilizing their non-precious transition metal based active sites.

FIG. 8b represents the current density (i) as a function of time (expressed in hours) with a PEMFC potential set to 0.5 V for the catalyst E tested over a time period of 200 hours. FIG. 8b shows that the stabilization observed over 50 hours (FIG. 6) is also effective over longer time periods such as 200 hours. As seen in the curve of FIG. 8b and the curve E of FIG. 6, we note that the final performance at 0.5 V is also similar to that observed after the 50 hour test.

FIG. 8c represents the catalytic activity with a PEMFC potential set to 0.8 V (current density divided by the total load of the P/Metal-N—C type catalyst E) for the tested catalyst E, before and after 200 hours of operation of the PEMFC. Given the uncertainty of the electrochemical activity measurement (in the range of more or less 20%), we note that the initial activity and the final activity are very similar. This demonstrates that the partially oxidized platinum in the catalyst according to the invention can stabilize the Fe—N—C catalyst in the long run, and also demonstrates that the platinum has not been reduced (activated) during the test at 0.5 V. On the contrary, a significant increase of the activity would have been observed after 200 hours, which is not the case.

FIG. 9 represents X-ray absorption spectra around the absorption threshold L₃ of platinum at 11562 eV (known as «XANES», standing for «X-ray Absorption Near Edge Structure») of the platinum atoms of the hybrid catalysts C and E according to the invention in comparison with the XANES spectrum around the absorption threshold L₃ of the platinum of a platinum metallic sheet in which the platinum atoms are in a metallic form. FIG. 9 represents the XANES spectra a few eV below the threshold L₃ of platinum up to 50 eV above this threshold.

In the platinum metallic sheet, the platinum atoms have a zero oxidation state and have a face-centered cubic crystalline structure (namely each platinum atom has 12 neighboring platinum atoms). The XANES spectrum of the metallic platinum nanoparticles of a platinum structure present in the platinum-based non-hybrid catalysts or in the Pt/Metal-N—C type hybrid catalysts of the related art is very similar to that of a platinum metallic sheet.

FIG. 10 represents an enlargement of the spectra of FIG. 9 at the absorption threshold L₃ of platinum, namely at 11562 eV.

The XANES portion of the absorption spectrum is characteristic of the local order around the X-ray absorber atom, herein platinum. Hence, according to FIGS. 9 and 10, the atom type and the number of atoms around the platinum atoms are fundamentally different between the hybrid catalyst according to the invention and the catalysts of the related art.

Considering the differences in the spectra of platinum between the catalysts according to the invention and the platinum metallic sheet, we note that the platinum that the catalysts according to the invention comprise has not a platinum structure in a metallic form (namely a face-centered cubic structure). In particular, between 11562 and 11565 eV, we note that the spectra of the catalysts according to the invention are positively shifted by 0.5-1.0 eV relative to the spectrum of the platinum metallic sheet. This positive shift by 0.5-1.0 eV relative to the platinum metallic sheet corresponds to an average oxidation state between 1.1 and 2.3 of the platinum atoms located in the Pt/Fe—N—C type hybrid catalysts according to the invention.

Thus, the average oxidation state of the platinum atoms of the hybrid catalysts according to the invention is not equal to zero as is the case for the platinum of the platinum metallic sheet. Hence, the platinum salt precursor has not been completely reduced during the manufacture of the catalyst according to the invention, that is to say during the heat treatment under a dihydrogen and dinitrogen gaseous mixture.

FIG. 11 is a graph of the Fourier transform of the X-ray absorption spectroscopy experimentations in fine structure (namely experimentations abbreviated hereinafter as «EXAFS», standing for «Extended X-ray Absorption Fine Structure») of the platinum of the hybrid catalysts C and E according to the invention in comparison with the Fourier transform of the EXAFS signal for the platinum of the platinum metallic sheet.

This analysis allows plotting the amplitude of the EXAFS signal (k²_{χ}(R)), which depends on the average number of neighboring atoms around each platinum atom, as a function of the distance between the absorber platinum atom and the neighboring atoms.

FIG. 11 shows that the structure at a long distance around the platinum atoms of the hybrid catalysts of the invention is also very different from that of the platinum atoms in a metallic face-centered cubic structure.

Indeed, as seen in FIG. 11, we note that the coordination number of the platinum of the catalysts according to the invention is lower than that of the platinum of the platinum metallic sheet.

The EXAFS signal observed at a radial distance of 2.5 Angstrom, a distance corresponding to the platinum atoms the closest to a given platinum atom, is actually lower for the platinum of the catalysts according to the invention than for the metallic platinum with a face-centered cubic structure of the platinum metallic sheet. This shows that the coordination number of the platinum by other platinum atoms is much smaller in the catalysts of the invention than in the platinum face-centered cubic structure whose coordination number is 12.

In addition, the EXAFS signal observed at 1.5 Å for the Pt/Fe—N—C type hybrid catalysts according to the invention may be attributed to platinum-carbon platinum-nitrogen bonds, namely bonds which are absent in the face-centered cubic structure of the platinum of the platinum metallic sheet.

FIG. 12 represents curves of an electrochemical detection test of carbon monoxide. The carbon monoxide is a molecule known for characterizing metallic platinum particles (platinum atoms having a zero oxidation state inside the particle). Conventionally, carbon monoxide is used in the electrochemical field in order to quantify the surface of reduced platinum based catalysts.

The carbon monoxide is first injected in the cell system in the form of gas at the cathode. The carbon monoxide molecule adsorbs strongly onto the reduced platinum surface, thereby covering its entire surface with one layer. Afterwards, the excess non-adsorbed carbon monoxide gas is purged away from the cathode with an inert gas which is dinitrogen. Only this one later of carbon monoxide adsorbed onto the reduced platinum remains present in the cathode (the potential of the cathode is controlled around 0 V during this time, in order to avoid any premature oxidation of the carbon monoxide).

Afterwards, the amount of adsorbed carbon monoxide is quantified by electrochemically desorbing the carbon monoxide (electrochemical oxidation of the carbon monoxide which then desorbs in an oxidized form), by progressively increasing the electrochemical potential of the cathode from 0 to 1 V.

The electric charge corresponding to the surface area below the carbon monoxide oxidation peak in the voltammogram is directly proportional to the amount of adsorbed carbon monoxide, and therefore to the surface area of the reduced platinum in the catalyst. The position of this carbon monoxide oxidation peak is at about 0.8 V vs. a hydrogen reference electrode.

FIG. 12 shows the comparison of the curves before and after a 50 hour test in PEMFC at 0.5 V carried out with the catalyst D.

More specifically, in FIG. 12:
the curve entitled «initial» represents the voltammogram determined after injection of carbon monoxide, and then dinitrogen at the cathode;
the curve entitled «blank» represents the voltammogram determined after injection of dinitrogen alone (and therefore without any injection of carbon monoxide);
the curve entitled «after 50 hours» represents the voltammogram determined after injection of carbon monoxide, dinitrogen at the cathode, and then the performance of a 50 hour functional test in PEMFC at 0.5 V.

FIG. 12 shows no signal corresponding to the electrochemical oxidation of carbon monoxide for the catalyst D, neither before nor after the 50 hour test in the cell. Indeed, the curve entitled «initial» is totally superimposes with the curve entitled «blank». This demonstrates that no carbon monoxide molecule has adsorbed onto the platinum of the hybrid catalyst according to the invention. This is unexpected and is explained by the different structure of the platinum particles and by the different condition of their surface in the catalyst according to the invention. This is also correlated with the inactivity of platinum for the dioxygen reduction.

FIG. 12 shows the absence of carbon monoxide adsorption onto the platinum present in the catalyst D. The absence of any oxidation peak (that is to say the oxidation of the carbon monoxide potentially adsorbed onto platinum, which is reflected by a positive current peak during the increase of the electrochemical potential from 0 to 1 V) demonstrates that the platinum is initially incapable of adsorbing the carbon monoxide. This is explained by the partially oxidized state of the platinum in the catalyst according to the invention. After 50 hours of operation in the cell at 0.5 V, the platinum is still incapable of adsorbing the carbon monoxide, thereby demonstrating that the platinum has not been reduced during the test in the cell.

FIG. 13 represents X-ray absorption spectra around the absorption threshold L₃ of platinum at 11562 eV of the platinum atoms of the catalyst D (that is to say the «XANES» spectra), before and after a test in the cell at 0.5 V for 50 hours. The superimposition of the spectra shows that the coordination and the average oxidation state of the platinum in the catalyst D has not changed during the test in the cell. Hence, the platinum is inactive for the oxygen reduction reaction throughout the test, but it stabilizes the catalytic sites of the FeNxCy type iron.

1. A P/Metal-N—C type hybrid catalyst which comprises at least one nitrogen-doped carbonaceous matrix on which is bonded in a covalent manner at least one non-precious transition metal, wherein it further comprises at least one precious transition metal P partially oxidized and whose weight percentage is lower than or equal to 4.0% with respect to the weight of the P/Metal-N—C type hybrid catalyst.

2. The P/Metal-N—C type hybrid catalyst according to claim 1, wherein the precious transition metal P is selected from ruthenium, rhodium, palladium, silver, gold, rhenium, osmium, iridium, platinum and cerium, considered alone or mixed with the latter or in the form of an alloy with at least one precious or non-precious transition metal.

3. The P/Metal-N—C type hybrid catalyst according to claim 1, wherein the non-precious transition metal is selected from titanium, vanadium, chromium, manganese, nickel, copper, iron and cobalt, considered alone or mixed with the latter or in the form of an alloy of non-precious transition metals.

4. The P/Metal-N—C type hybrid catalyst according to claim 1, wherein the precious transition metal P has an average oxidation state comprised between 0.5 and 4.0.

5. The P/Metal-N—C type hybrid catalyst according to claim 1, wherein the weight percentage of the precious transition metal P is comprised between 0.1% and 4.0% with respect to the weight of the P/Metal-N—C type hybrid catalyst.

6. The P/Metal-N—C type hybrid catalyst according to claim 1, wherein the precious transition metal P is in the form of nanoparticles.

7. The P/Metal-N—C type hybrid catalyst according to claim 6, wherein it comprises micropores and/or mesopores in which lie the nanoparticles of the precious transition metal P.

8. A P/Metal-N—C type hybrid catalyst which can be obtained by a manufacturing method which comprises at least the following steps of:
a) providing a Metal-N—C type hybrid catalyst,
b) impregnating the Metal-N—C type hybrid catalyst with at least one solution of a salt of a precious transition metal P so as to obtain a homogenous mixture,
c) performing at least one heat treatment on the homogenous mixture obtained at step b), the heat treatment consisting of a heating at a temperature comprised between 0 and 700° C., in an inert or reducing atmosphere so as to obtain a P/Metal-N—C type hybrid catalyst in which the precious transition metal P is partially oxidized,
the concentration of the solution of the salt of the precious transition metal P being selected in a determined manner such that the weight percentage of the precious transition metal P is lower than or equal to 4.0% with respect to the weight of the P/Metal-N—C type hybrid catalyst obtained upon completion of step c).

9. An electrochemical device which comprises at least one P/Metal-N—C type hybrid catalyst according to claim 1.

10. The electrochemical device according to claim 9, wherein it is selected from metal-air batteries, fuel cells operating at low temperature.
